(19) United States
(12) Patent Application Publication
(10) Pub. No.: US 2023/0366427 A1
(43) Pub. Date: Nov. 16, 2023

(54) OPERATING DEVICE

(71) Applicant: HI-LEX CORPORATION, Takarazuka-shi, Hyogo (JP)

(72) Inventors: Hidenori TOKIMASA, Takarazuka-shi, Hyogo (JP); Atsushi NISHIMURA, Takarazuka-shi, Hyogo (JP)

(21) Appl. No.: 18/246,462

(22) PCT Filed: Sep. 24, 2021
(86) PCT No.: PCT/JP2021/034928

§ 371 Date: Mar. 23, 2023

(30) Foreign Application Priority Data
Sep. 24, 2020 (JP) 2020-159923

(51) Int. Cl. F16C 1/14

(52) U.S. Cl. CPC F16C 1/14; F16C 2350/52; F16C 2361/41

(57) ABSTRACT

The operating device comprises a cable having a cable end, a coupling member, and a base. The coupling member has a coupling member-side facing surface facing the cable end, the coupling member-side facing surface is provided to the base so as to be inclined at a predetermined inclination angle with respect to the coupling member-side facing surface in an unloaded state, and the cable end has a cable end-side facing surface facing the coupling member-side facing surface. The coupling member-side facing surface and the cable end-side facing surface are configured not to interfere with each other when the coupling member is inclined.

### TECHNICAL FIELD

The present invention relates to an operating device.

### BACKGROUND ART

Patent Document 1 discloses a cable device that unlocks a hood lock device with a cable. The cable device of Patent Document 1 comprises a hood opener for unlocking a hood lock, a first cable and a second cable each having one end thereof connected to a first device and a second device such as two hood lock devices, respectively, a third cable having one end thereof connected to an operating device, and a pulley to which other ends of these three cables are connected. The pulley is rotatably supported by a housing.

### PRIOR ART DOCUMENT

### Patent Document

Patent Document 1: DE 102008034770 A

### SUMMARY OF THE INVENTION

### Problem to be Solved by the Invention

When a predetermined tension or more is applied to a cable, a member to which a cable end of the cable is connected may be inclined with respect to a normal state (a state before the predetermined tension or more is applied to the cable), as in the case for the pulley of Patent Document 1. For example, in a case where, in mounting a pulley to a rotation axis, the rotation axis elastically deforms, thereby snap-fit connecting the pulley and the rotation axis, when a predetermined force or more is applied to the cable, the pulley may be inclined with respect to a normal state due to the deformation of the rotation axis.

When the member to which the cable end is connected (hereinafter referred to as a coupling member), such as a pulley, is inclined with respect to the normal state, the cable end accommodated in the coupling member may also be inclined according to the inclination of the coupling member, depending on a shape of the cable end. If the cable end is inclined according to the inclination of the coupling member, bending deformation of the cable occurs in the vicinity of the cable end. If this bending deformation occurs repeatedly, there is a possibility that the cable may be fatigue-broken in the vicinity of the cable end.

Therefore, it is an object of the present invention to provide an operating device capable of suppressing inclination of a cable end due to inclination of a coupling member to which a cable is connected and suppressing fatigue breakage of the cable resulting from bending deformation of the cable due to the inclination of the cable end.

### Means to Solve the Problem

The present invention is an operating device comprising: a cable having a cable end; a coupling member to which the cable end is coupled, the coupling member being activated when the cable is operated; and a base to which the coupling member is operably provided, wherein the coupling member comprises a connecting part to which the cable end is connected, wherein the connecting part has a coupling member-side facing surface facing a part of the cable end when the cable end is connected to the connecting part, wherein the coupling member-side facing surface of the coupling member is provided to the base so as to be inclined at a predetermined inclination angle with respect to a reference plane when the coupling member is in a predetermined loaded state where a predetermined load or more is applied from the cable, and the reference plane is a position of the coupling member-side facing surface in an unloaded state where no load is applied from the cable, wherein the cable end has a cable end-side facing surface facing the coupling member-side facing surface, and wherein the coupling member-side facing surface and the cable end-side facing surface are configured not to interfere with each other when the coupling member is inclined with respect to the reference plane.

### Effects of the Invention

According to the operating device of the present invention, it can suppress inclination of a cable end due to inclination of a coupling member to which a cable is connected and suppress fatigue breakage of the cable resulting from bending deformation of the cable due to the inclination of the cable end.

### BRIEF DESCRIPTION OF THE DRAWINGS

FIG. 1 is a top view of an operating device according to one embodiment of the present invention, showing a state where a coupling member is located at an initial position.

FIG. 2 is a top view of the operating device according to one embodiment of the present invention, showing a state where the coupling member is moved from the state shown in FIG. 1 to an operation position with a cable.

FIG. 3 is an exploded perspective view of the operating device shown in FIG. 1.

FIG. 4 (A) is a side view of a cable end used in the operating device of FIG. 1, (B) is a front view of the cable end of (A), and (C) is a bottom view of the cable end of (A).

FIG. 5 is a perspective view of a base used in the operating device of FIG. 1.

FIG. 6 (A) is a perspective view showing the upper side of the coupling member used in the operating device of FIG. 1 and (B) is a perspective view showing the bottom side of the coupling member of (A).

FIG. 7 is a schematic cross-sectional view showing the coupling member and the base when the coupling member is in an unloaded state.

FIG. 8 is a schematic cross-sectional view showing the coupling member and the base when a load is applied to the coupling member from the cable and the coupling member is inclined.

FIG. 9 is a partially enlarged view of FIG. 8 showing a coupling member-side facing surface and a cable end-side facing surface in a state where the coupling member is inclined.

FIG. 10 is a view showing a modified example of the operating device.

FIG. 11 is a schematic view showing a reference example having cable ends and a coupling member that have no configuration of the present invention.

### EMBODIMENT FOR CARRYING OUT THE INVENTION

Hereinafter, the operating device according to one embodiment of the present invention will be described with reference to the drawings. Besides, embodiments shown below are merely examples, and the operating device of the present invention is not limited to the following embodiments.

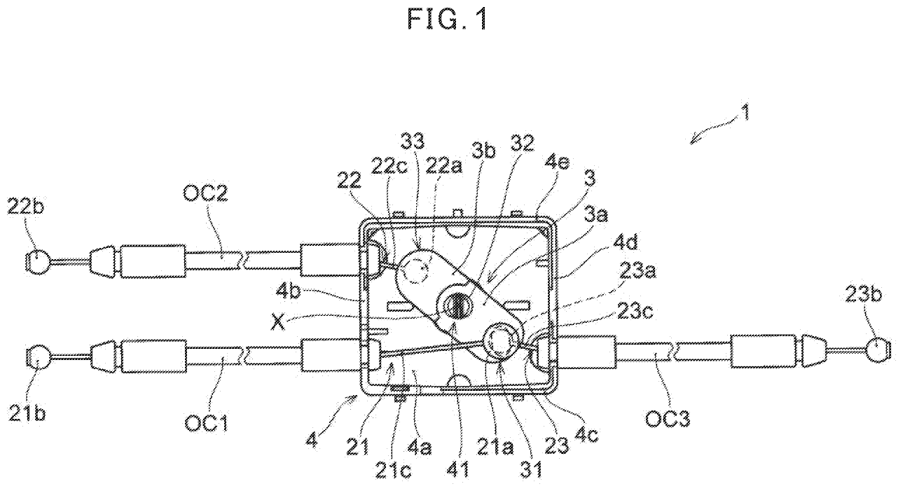

As shown in FIGS. 1 to 3, the operating device 1 of the present embodiment comprises a cable 21 having a cable end 21a, a coupling member 3 to which the cable end 21a is coupled, the coupling member 3 being activated when the cable 21 is operated, and a base 4 to which the coupling member 3 is operably provided.

The operating device 1 activates the coupling member 3 via the cable end 21a by operating the cable 21, thereby operating a predetermined operation target that is not shown. The structure of the operating device 1 is not limited as long as the operating device 1 activates the coupling member 3 via the cable end 21a by operating the cable 21, thereby allowing for operation of the predetermined operation target.

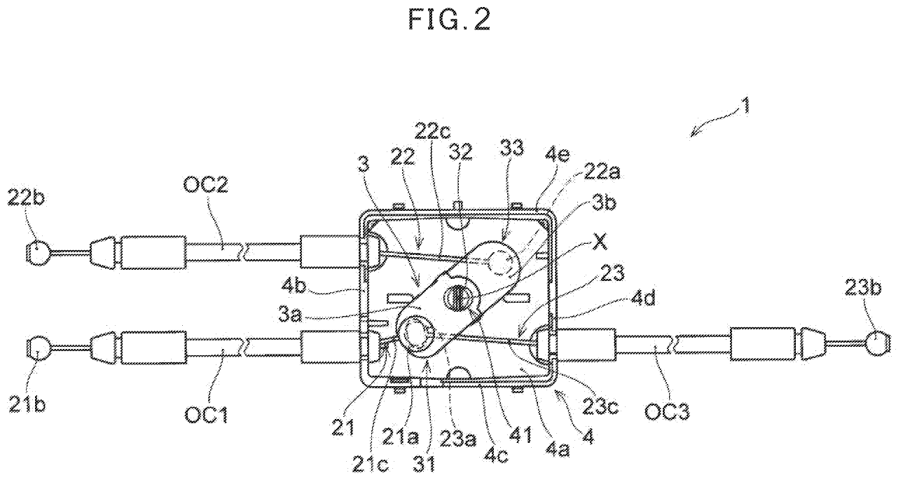

In the present embodiment, as shown in FIGS. 1 and 2, the operating device 1 is configured so that the coupling member 3 rotates by operation of the cable 21. However, the operating device 1 may be configured so that the coupling member 3 linearly moves by operation of the cable 21 (for example, a slider (a coupling member) to which a cable is coupled moves linearly inside a base configured as a casing).

In the present embodiment, as shown in FIGS. 1 and 2, the operating device 1 is configured to operate a driven member (in the present embodiment, the second cable 22 or the third cable 23) connected to the coupling member 3 by activating the coupling member 3 with the cable 21 to operate the operation target by the driven member. The structure of the driven member connected to the coupling member 3 is not limited as long as the driven member activates according to the movement of the coupling member 3. The driven member may be a cable or have other structures such as a rod. Also, the number of driven members may be one or more. In the present embodiment, the driven member is a cable. Specifically, as shown in FIGS. 1 to 3, the operating device 1 comprises a second cable 22 and a third cable 23, both of which are operated via the coupling member 3 when the coupling member 3 is operated by the cable (first cable) 21.

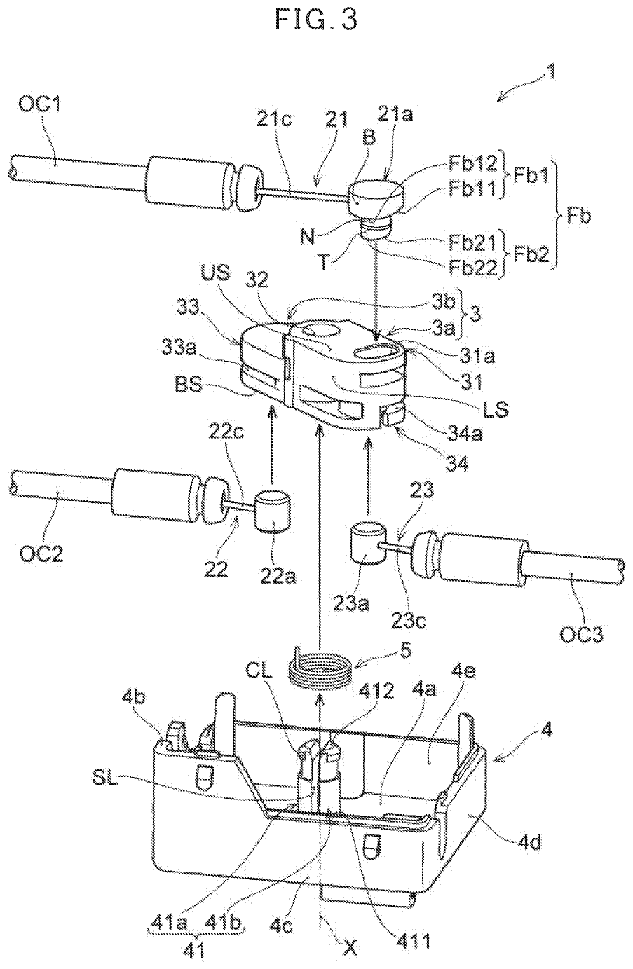

As shown in FIG. 1, in the coupling member 3, a second cable end 22a of the second cable 22 is mounted to an opposite side to the cable end (first cable end) 21a of the cable 21 across a shaft part 41, which will be described later. In the coupling member 3, a third cable end 23a of the third cable 23 is mounted at the same position as a position of the cable end 21a of the cable 21 in a rotation direction of the coupling member 3, and the cable end 21a of the cable 21 and the third cable end 23a of the third cable 23 are provided so as to be aligned in a direction of an axis X (see FIG. 3) of the shaft part 41.

The operation target of the operating device 1 is not limited as long as the operation target is operated by activating the coupling member 3 via the cable end 21a by operation of the cable 21. In the present embodiment, the second cable 22 and the third cable 23 are connected to different operation targets, respectively, and configured to operate the different operation targets in conjunction with the operation of the cable 21. Specifically, the cable 21 has an operation part (not shown) for operating the cable 21 at an opposite end (a cable end 21b) to the cable end 21a. When the cable 21 is operated by the operation part, the coupling member 3 rotates around the axis X of the shaft part 41 to operate the second cable 22 and the third cable 23. This allows for the different operation targets to be operated with each of the second cable 22 and the third cable 23.

Although application to which the operating device 1 is applied is not limited, but, for example, the operating device 1 may be applied to a hood opener of an engine hood of a vehicle having two locking parts each of which the second cable 22 and the third cable 23 are connected to, or an unlocking mechanism such as a reclining mechanism of a seat having two locking parts.

Each configuration of the operating device 1 of the present embodiment will be described below, but the following description does not limit the operating device of the present invention.

The cable 21 applies an operating force to the coupling member 3 via the cable end 21a by operation of the cable 21. As shown in FIGS. 1 and 2, the cable 21 comprises a cable body 21c, a cable end 21a provided at one end of the cable body 21c, and a cable end 21b provided at the other end of the cable body 21c. In the present embodiment, the cable end 21a provided atone end of the cable body 21c is connected to the coupling member 3. The cable end 21b provided at the other end of the cable body 21c is connected to an operation part (not shown) for operating the cable 21. The operation part for operating the cable 21 may be a manual operation part such as a lever, or may be an electric operation part such as a motor.

The structure of the cable 21 is not limited as long as an operating force may be applied to the coupling member 3 via the cable end 21a. For example, the cable 21 may be a publicly-known inner cable of a control cable. In the present embodiment, as shown in FIGS. 1 to 3, the cable 21 is accommodated in an outer casing OC1 and routed along a predetermined routing path in a mounting target (e.g., a vehicle) of the operating device 1. One end of the outer casing OC1 is mounted to the base 4, and the other end of the outer casing OC1 is mounted to the operation part side.

The cable end 21b is operated by the operation part so as to operate the cable 21 in a predetermined direction. A shape and structure of the cable end 21b are not limited, and may be any shape and structure.

The cable end 21a is connected to the coupling member 3 to transmit the operating force of the cable 21 to the coupling member 3. As will be described later, the shape and structure of the cable end 21a is not limited as long as the cable end 21a is configured so that the coupling member-side facing surface Fa and the cable end-side facing surface Fb, which will be described later, are configured not to interfere with each other when the coupling member 3 is inclined. Besides the shape shown in the figure, the cable end 21a is preferably a cable end having a flat surface (an inclined surface as necessary) on the cable end-side facing surface Fb of the cable end 21a, such as a substantially cylindrical cable end and a substantially polygonal cable end, which have a flat surface on the cable end-side facing surface Fb.

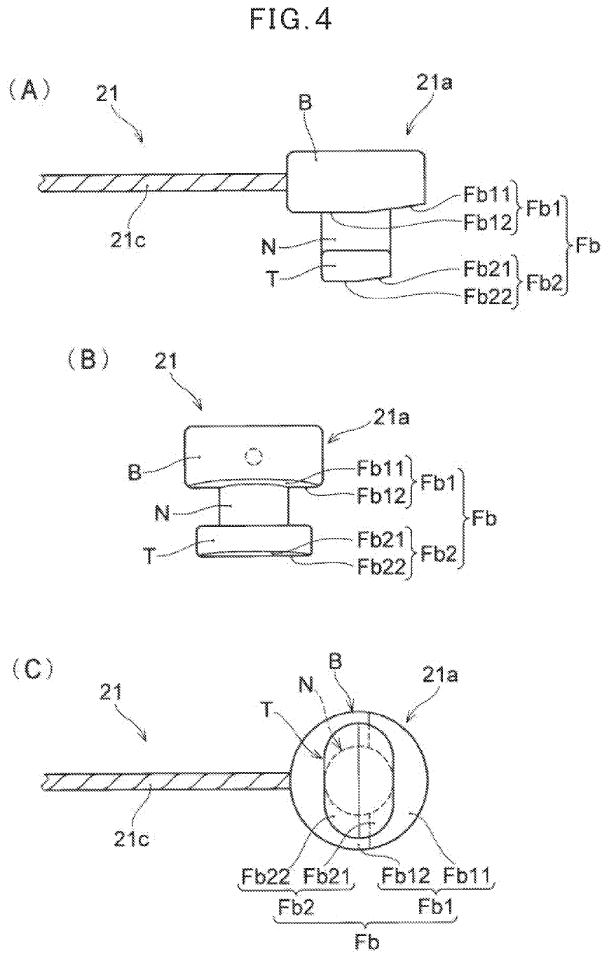

In the present embodiment, the cable end 21a has a key-shaped structure to suppress detachment from the coupling member 3. Specifically, as shown in FIGS. 4 (A) to (C), the cable end 21a has: a cable end base end part B to which the cable body 21c is connected; a neck part N that extends perpendicularly to an extending direction of the cable 21 with respect to the cable end base end part B and is one size smaller than the cable end base end part B; and a cable end tip part T that extends from the neck part N in a direction opposite to the cable end base end part B and partially protrudes outwardly with respect to the periphery of the neck part N. The cable end base end part B is formed in a flat, substantially cylindrical shape. The neck part N is formed in a substantially cylindrical shape having a small diameter and provided coaxially with the cable end base end part B, the outer diameter of which is smaller than that of the cable end base end part B. The cable end tip part T is formed in a columnar shape having a substantially elliptical cross section. As shown in FIGS. 4 (A) to (C), inclined surfaces Fb11, Fb21, which will be described later, are provided to the cable end base end part B and the cable end tip part T, respectively.

The second cable 22 is operated with the coupling member 3 by operating the coupling member 3 with the cable 21. As shown in FIGS. 1 and 2, the second cable 22 comprises a cable body 22c, a cable end (a second cable end) 22a provided at one end of the cable body 22c, and a cable end 22b provided at the other end of the cable body 22c. In the present embodiment, the cable end 22a provided at one end of the cable body 22c is connected to the coupling member 3. The cable end 22b provided at the other end of the cable body 22c is connected to an operation target that is not shown.

The structure of the second cable 22 is not limited, and for example, the second cable 22 may be a known inner cable of a control cable. In the present embodiment, as shown in FIGS. 1 to 3, the second cable 22 is accommodated in an outer casing OC2 and routed along a predetermined routing path by the outer casing OC2 in a mounting target (e.g., a vehicle) of the operating device 1. One end of the outer casing OC2 is mounted to the base 4, and the other end of the outer casing OC2 is mounted to the operation target side. Shapes and structures of the cable ends 22a, 22b are not limited, and may be publicly-known shapes. The structure of the cable end 22a may be similar to that of the cable end 21a.

The third cable 23 is operated with the coupling member 3 by operating the coupling member 3 with the cable 21. As shown in FIGS. 1 and 2, the third cable 23 comprises a cable body 23c, a cable end (a third cable end) 23a provided at one end of the cable body 23c, and a cable end 23b provided at the other end of the cable body 23c. In the present embodiment, the cable end 23a provided at one end of the cable body 23c is connected to the coupling member 3. The cable end 23b provided at the other end of the cable body 23c is connected to an operation target that is not shown.

The structure of the third cable 23 is not limited, and for example, the third cable 23 may be a publicly-known inner cable of a control cable. In the present embodiment, as shown in FIGS. 1 to 3, the third cable 23 is accommodated in an outer casing OC3 and routed along a predetermined routing path by the outer casing OC3 in a mounting target (e.g., a vehicle) of the operating device 1. One end of the outer casing OC3 is mounted to the base 4, and the other end of the outer casing OC3 is mounted to the operation target side. Shapes and structures of the cable ends 23a, 23b are not limited, and may be publicly-known shapes. The structures of the cable end 23a, 23b may be similar to that of the cable end 21a.

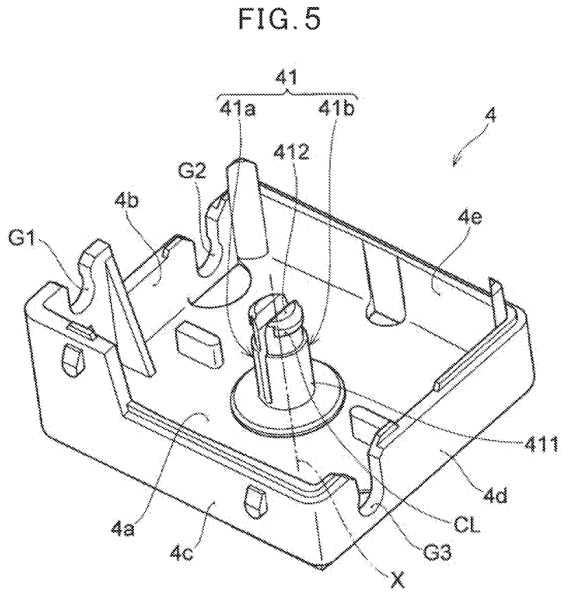

The base 4 is a part to which the coupling member 3 is operably supported. The structure of the base 4 is not limited as long as the coupling member 3 may be operably provided. In the present embodiment, the base 4 is configured as a housing accommodating the coupling member 3. Specifically, as shown in FIGS. 1 to 3 and 5, the base 4 comprises a bottom plate 4a, and side walls 4b, 4c, 4d, 4e standing from the bottom plate 4a. The base 4 is configured to be closed with a lid member that is not shown, in a state where the coupling member 3 is accommodated therein. The side walls 4b, 4d have engagement grooves G1, G2, G3 with which terminal members provided at the ends of the outer casings OC1, OC2, OC3 can engage. The outer casings OC1, OC2, OC3 are mounted to the side walls 4b, 4d. In the present embodiment, the base 4 is configured to have a substantially rectangular parallelepiped shape with being closed with the lid member, but a shape of the base 4 is not limited.

The base 4 comprises a shaft part 41 serving as a rotation axis of the coupling member 3. As shown in FIGS. 1 and 2, the coupling member 3 is mounted to the shaft part 41 so as to be rotatable about the axis X of the shaft part 41. As mentioned above, the coupling member may be provided so as to be linearly movable with respect to the base 4, and the base 4 may be configured to guide the coupling member configured as a slider so as to be linearly movable.

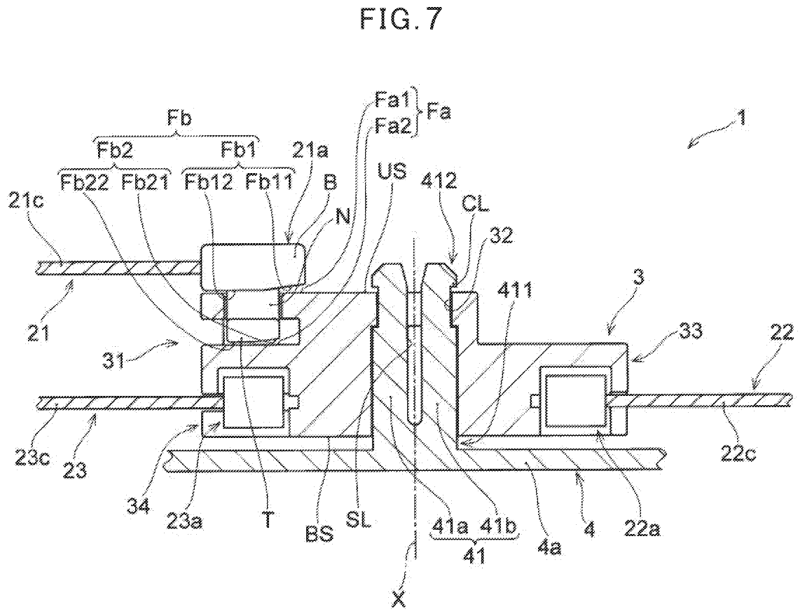

In the present embodiment, the shaft part 41 extends in a direction substantially perpendicular to the bottom plate 4a of the base 4 (see FIG. 7). The shaft part 41 is inserted through an insertion part 32 (see FIG. 3) provided in the coupling member 3 to rotatably support the coupling member 3. In the present embodiment, the shaft part 41 comprises a plurality of shaft members 41a, 41b separated from each other by a slit SL extending along the direction of the axis X of the shaft part 41. The shaft members 41a, 41b extend from a base end part 411 on the bottom plate 4a side of the base 4 to a tip part 412 side having a claw part CL.

In the present embodiment, the shaft part 41 is separated into the plurality of shaft members 41a, 41b in the direction perpendicular to the axis X by the slit SL. Therefore, when the coupling member 3 is mounted to the shaft part 41, the shaft part 41 can be elastically deformed so as to narrow the width of the slit SL. After the coupling member 3 is mounted to the shaft part 41, the shaft members 41a, 41b are elastically returned so as to widen the width of the slit SL, thereby suppressing the detachment of the coupling member 3. More specifically, for the shaft part 41, after the coupling member 3 is mounted to the shaft part 41, with the claw part CL provided on the tip part 412 side of the shaft members 41a, 41b, the claw part CL and the upper surface US of the coupling member 3 engage with each other to further suppress the coupling member 3 from being detached from the shaft part 41. In the present embodiment, the shaft part 41 is configured by two shaft members 41a, 41b separated by one slit SL. However, the number of slit and the number of shaft member are not limited. Moreover, the plurality of shaft members 41a, 41b may be formed integrally or may be configured separately.

The coupling member 3 is coupled with the cable end 21a of the cable 21 and activates when the cable 21 is operated. In the present embodiment, as shown in FIGS. 1 and 2, the coupling member 3 is configured to perform rotational movement, but the coupling member may be configured to perform movement other than the rotational movement, e.g., linear movement as mentioned above. The coupling member 3 is activated when the cable 21 is operated so that the coupling member 3 operates a predetermined operation target. In the present embodiment, when the coupling member 3 is activated, the second cable 22 and the third cable 23 are operated by the coupling member 3, thereby operating the operation target connected to the second cable 22 and the third cable 23.

A shape and structure of the coupling member 3 are not limited as long as the cable end 21a of the cable 21 may be coupled to the coupling member 3 and the coupling member 3 may be activated when the cable 21 is operated. In the present embodiment, the coupling member 3 comprises a connecting part 31 to which the cable end 21a is connected. Moreover, in the present embodiment, the coupling member 3 comprises an insertion part 32 through which the shaft part 41 is inserted, a second connecting part 33 to which the second cable end 22a of the second cable 22 is connected, and a third connecting part 34 to which the third cable end 23a of the third cable 23 is connected.

The connecting part 31 is a predetermined region of the coupling member 3 to which the cable end 21a is connected. The connecting part 31 includes not only an engaging portion receiving force from the cable end 21a when the cable 21 is operated but also a surrounding portion of the engaging portion. In the present embodiment, the connecting part 31 is a recessed part having an internal space capable of accommodating the cable end 21a. In the present embodiment, in the connecting part 31, the neck part N and the cable end tip part T of the cable end 21a are accommodated in the internal space of the connecting part 31, and the cable end base end part B of the cable end 21a is located outside the coupling member 3. The connecting part 31 has an opening 31a having a shape corresponding to the shape of the cable end tip part T so that the cable end tip part T of the cable end 21a can be accommodated into the internal space. In the present embodiment, the opening 31a has a shape similar to that of the cable end tip part T of the cable end 21a, that is, an elliptical shape that is one size larger than the cable end tip part T. The internal space of the connecting part 31 extends in the X-axis direction from the upper surface US of the coupling member 3 with a size and length corresponding to the neck part N of the cable end 21a, and then expands into a direction perpendicularly to the X-axis direction of the shaft part 41. Details of the connecting part 31 will be described later.

The insertion part 32 is configured such that the shaft part 41 is inserted through the insertion part 32. In the present embodiment, the insertion part 32 has a through hole penetrating the coupling member 3 in the direction of the axis X.

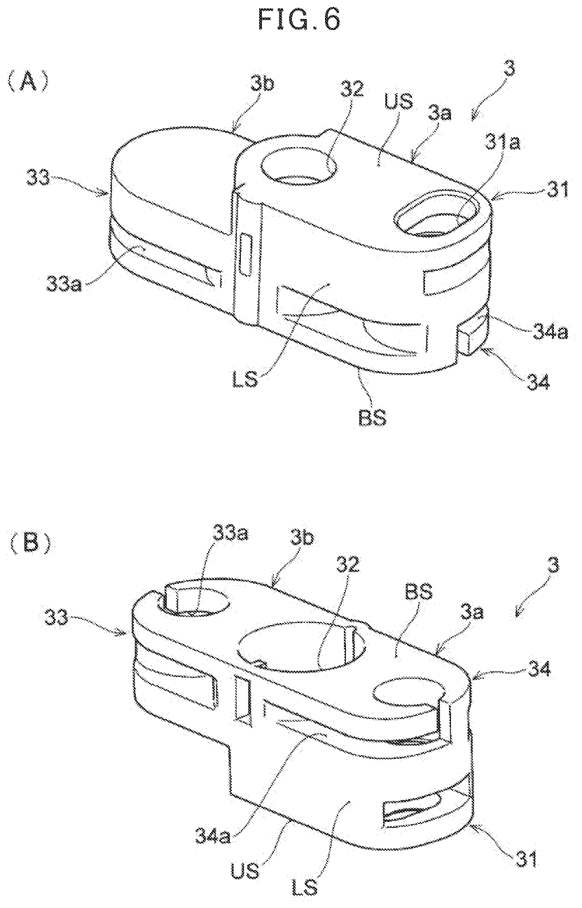

The second connecting part 33 has an internal space to which the second cable end 22a is connectable. In the present embodiment, the second connecting part 33 has a substantially cylindrical inner space so as to accommodate a substantially cylindrical second cable end 22a. The second connecting part 33 has a circular opening on the bottom surface BS of the coupling member 3, as shown in FIG. 6 (B). On the lateral side LS of the coupling member 3 provided with the second connecting part 33, a cable passage slit 33a, through which the second cable 22 can pass, is provided so as to correspond to a change in an extending direction of the second cable 22 from the coupling member 3 (see FIGS. 1 and 2) when the coupling member 3 rotates.

Moreover, the third connecting part 34 has an internal space to which the third cable end 23a is connectable. In the present embodiment, the third connecting part 34 has a substantially cylindrical inner space so as to accommodate a substantially cylindrical third cable end 23a. The third connecting part 34 has a circular opening on the bottom surface BS of the coupling member 3, as shown in FIG. 6 (B). On the lateral side LS of the coupling member 3 provided with the third connecting part 34, a cable passage slit 34a, through which the third cable 23 can pass, is provided so as to correspond to a change in an extending direction of the third cable 23 from the coupling member 3 (see FIGS. 1 and 2) when the coupling member 3 rotates. Shapes and structures of the second connecting part 33 and the third connecting part 34 are not limited as long as the second connecting part 33 and the third connecting part 34 can engage the second cable end 22a and the third cable end 23a.

Although an overall shape of the coupling member 3 is not limited, in the present embodiment, the coupling member 3 comprises a first part 3a extending from the insertion part 32 in one direction perpendicular to the direction of the axis X of the shaft part 41 and a second part 3b extending from the insertion part 32 in the other direction perpendicular to the direction of the axis X (opposite direction to the first part 3a), in a state where the coupling member 3 is mounted to the shaft part 41. In the present embodiment, the first part 3a and the second part 3b extend so as to be in linear shapes when the coupling member 3 is viewed in the direction of the axis X of the shaft part 41, as shown in FIGS. 1 and 2. It should be noted that the coupling member 3 may have a circular shape, such as a pulley, or a sector shape.

In the present embodiment, as shown in FIGS. 6 (A), (B) and 7, the connecting part 31 and the third connecting part 34 are provided so as to align in the direction of the axis X of the shaft part 41 in the first part 3a. The second connecting part 33 is provided to the second part 3b. Since two connecting parts 31, 34 are provided to the first part 3a, the first part 3a is thicker in the direction of the axis X of the shaft part 41 compared to the second part 3b. The second connecting part 33 and the third connecting part 34 are provided at substantially the same positions in the direction of the axis X of the shaft part 41 (positions with substantially the same distance from the surface of the bottom plate 4a). The connecting part 31 is provided at a different position in the direction of the axis X of the shaft part 41 from the second connecting part 33 and the third connecting part 34 (position farther away from the surface of the bottom plate 4a).

In the present embodiment, the coupling member 3 is biased in one direction in the rotational direction of the coupling member 3 with a biasing member 5 (see FIG. 3). Specifically, the coupling member 3 is configured to be biased with the biasing member 5 to be held at an initial position (see FIG. 1) before being operated by the cable 21. Although a structure of the biasing member 5 is not limited, in the present embodiment, the biasing member 5 is a torsion spring having one end mounted to the coupling member 3 and the other end mounted to the base 4.

In the present embodiment, when the cable 21 is operated at the initial position shown in FIG. 1, the coupling member 3 receives force from the cable end 21a connected to the connecting part 31 to rotate around the axis X (clockwise in FIG. 1) (see FIG. 2). When the coupling member 3 rotates about the axis X from the initial position in FIG. 1 to the operation position in FIG. 2, the second cable 22 is pulled to the coupling member 3 side, and the third cable 23 is also pulled to the coupling member 3 side. This allows for the second cable 22 and the third cable 23 to be operated by operation of one cable 21 to operate two operation targets.

Next, details of the connecting part 31 of the coupling member 3 and the cable end 21a will be described.

As shown in FIG. 7, the connecting part 31 has a coupling member-side facing surface Fa facing a part of the cable end 21a when the cable end 21a is connected to the connecting part 31. As shown in FIG. 7, the cable end 21a has a cable end-side facing surface Fb facing the coupling member-side facing surface Fa.

The coupling member-side facing surface Fa is a part facing the cable end 21a, that is, a part facing the cable end-side facing surface Fb. In the specification, “facing” may be facing each other while being in contact with each other, or may be facing with a slight gap therebetween, such as facing between the inclined surfaces Fb11, Fb21, which will be described later. The coupling member-side facing surface Fa may face the cable end-side facing surface Fb of the cable end 21a in any direction. In the present embodiment, as shown in FIG. 7, the coupling member-side facing surface Fa faces the cable end-side facing surface Fb in a direction perpendicular to the extending direction of the cable 21, more specifically, in the direction of the axis X of the shaft part 41 (or a direction perpendicular to the bottom plate 4a of the base 4).

The coupling member-side facing surface Fa may be configured by only one surface or a plurality of surfaces separated from each other as in the present embodiment. In the present embodiment, as shown in FIG. 7, the coupling member-side facing surface Fa has a first coupling member-side facing surface Fa1 and a second coupling member-side facing surface Fa2. More specifically, the first coupling member-side facing surface Fa1 is a portion of an upper surface US (an opposite surface in the direction of the axis X of the shaft part 41 with respect to the bottom surface BS facing the bottom plate 4a of the base 4) of the coupling member 3 facing a first cable end-side facing surface Fb1 which will be described later. The second coupling member-side facing surface Fa2 corresponds to a bottom surface of the recessed part of the connecting part 31 facing a second cable end-side facing surface Fb2 which will be described later. In the present embodiment, in an unloaded state, a part of the first coupling member-side facing surface Fa1 is in contact with a part of the first cable end-side facing surface Fb1 (flat surface Fb12 which will be described later) in the direction of the axis X of the shaft part 41, and a part of the second coupling member-side facing surface Fa2 is in contact with a part of the second cable end-side facing surface Fb2 (flat surface Fb22 which will be described later) in the direction of the axis X of the shaft part 41.

In the present embodiment, the coupling member-side facing surface Fa is configured only by a flat surface extending substantially perpendicularly to the direction of the axis X of the shaft part 41 in an unloaded state where no load is applied to the coupling member 3. However, the coupling member-side facing surface Fa may have an inclined surface inclined with respect to the flat surface extending substantially perpendicularly to the direction of the axis X of the shaft part 41, as shown in a modified example which will be described later (see FIG. 10). In case that the coupling member-side facing surface Fa has an inclined surface, the inclined surface may be a flat surface or a curved surface. Moreover, the coupling member-side facing surface Fa may partially have concave and convex on its surface, for example, by providing lightening holes or the like.

The cable end-side facing surface Fb is a part facing the connecting part 31, that is, a part facing the coupling member-side facing surface Fa. The cable end-side facing surface Fb may face the coupling member-side facing surface Fa of the connecting part 31 in any direction. In the present embodiment, as shown in FIG. 7, the cable end-side facing surface Fb faces the coupling member-side facing surface Fa in a direction perpendicular to the extending direction of the cable 21, more specifically, in the direction of the axis X of the shaft part 41 (or a direction perpendicular to the bottom plate 4a of the base 4).

The cable end-side facing surface Fb may be configured by only one surface or a plurality of surfaces separated from each other as in the present embodiment. In the present embodiment, as shown in FIG. 7, the cable end-side facing surface Fb has a first cable end-side facing surface Fb1 and a second cable end-side facing surface Fb2. More specifically, the first cable end-side facing surface Fb1 is a surface facing the first coupling member-side facing surface Fa1, of the cable end base end part B of the cable end 21a. The second cable end-side facing surface Fb2 is a surface facing the second coupling member-side facing surface Fa2, of the cable end tip part T of the cable end 21a.

In the present embodiment, as shown in FIG. 7, the cable end-side facing surface Fb has flat surfaces Fb12, Fb22 extending substantially perpendicularly to the direction of the axis X of the shaft part 41 and inclined surfaces Fb11, Fb21 inclined with respect to the flat surfaces Fb12, Fb22, in an unloaded state where no load is applied to the coupling member 3. However, the cable end-side facing surface Fb may be configured only by a flat surface extending substantially perpendicularly to the shaft part 41 as in a modification example which will be described later. In case that the cable end-side facing surface Fb has an inclined surface, the inclined surface may be a flat surface or a curved surface. Moreover, the cable end-side facing surface Fb may partially have concave and convex on its surface, for example, by providing lightening holes or the like.

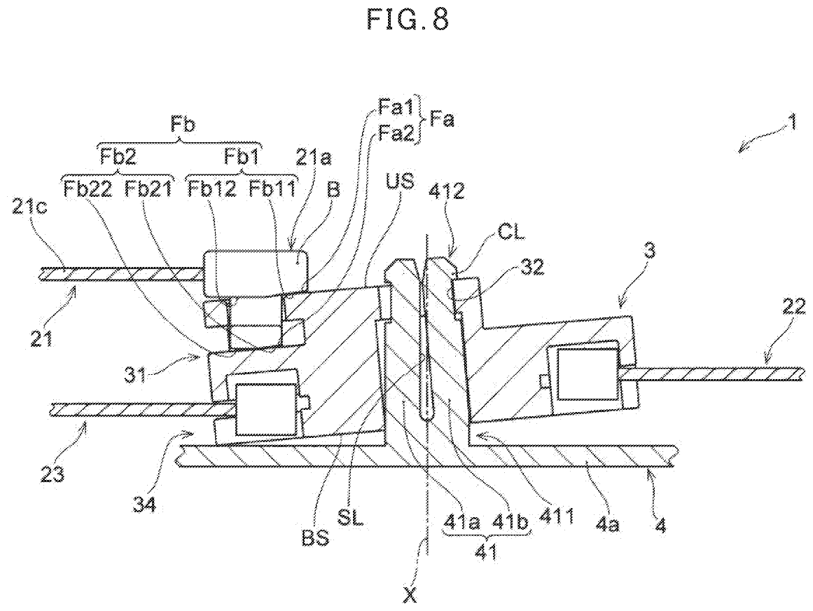

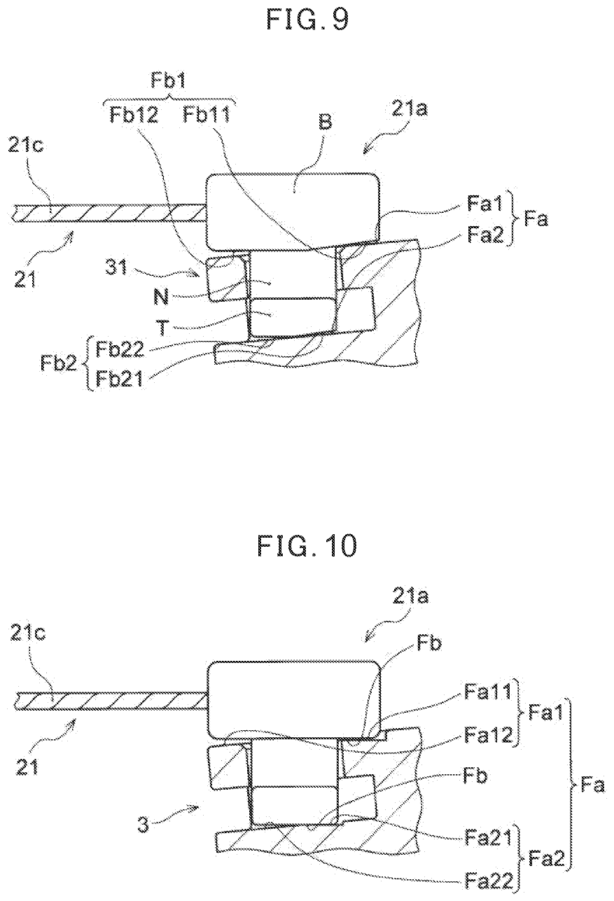

In the present embodiment, the coupling member-side facing surface Fa of the coupling member 3 is provided to the base 4 so as to be inclined at a predetermined inclination angle (see FIGS. 8 and 9) with respect to a reference plane (see FIG. 7) when the coupling member 3 is in a predetermined loaded state where a predetermined load or more is applied from the cable 21. The reference plane is the position of the coupling member-side facing surface Fa in an unloaded state where no load is applied from the cable 21. In other words, the coupling member 3 and the base 4 have structures such that, when force is applied to the coupling member 3 such as by pulling the cable 21, the coupling member 3 may have an inclined posture with respect to the unloaded state. The predetermined loaded state where the predetermined load or more is applied is a state where a load, by which the coupling member 3 is inclined, is applied. This predetermined load applied when the coupling member 3 is inclined is not limited since the load changes depending on shapes, structures, etc. of the coupling member 3 and the base 4. The predetermined inclination angle is not limited since the angle changes according to a load applied to the cable 21, etc. In the present embodiment, when a load is applied from the cable 21, as shown in FIGS. 8 and 9, the coupling member 3 is inclined so that the separation distance from the base 4 (bottom plate 4a) to the coupling member-side facing surface Fa of the coupling member 3 at the cable body 21c side (at a side of a direction in which the cable 21 is pulled) becomes shorter than the separation distance from the base 4 (bottom plate 4a) to the coupling member-side facing surface Fa of the coupling member 3 at the side opposite to the cable body 21c (at a side opposite to the direction in which the cable 21 is pulled). In the normal operation of the coupling member 3 (the operation from the state shown in FIG. 1 to the state shown in FIG. 2), the coupling member 3 is operated without being substantially inclined with respect to the base 4 (bottom plate 4a) (operated in a direction parallel to the bottom plate 4a of the base 4).

In the present embodiment, in the predetermined loaded state, the shaft members 41a, 41b receive force from the coupling member 3 so that the tip part 412 is deflected inwardly in a radial direction of the shaft part 41 with respect to the base end part 411 of the shaft members 41a, 41b, thereby inclining the coupling member 3 mounted to the shaft part 41. Specifically, the coupling member 3 moves from the position in the unloaded state shown in FIG. 1 to a predetermined position (for example, the position shown in FIG. 2), and in this state, it is assumed that the operation target can no longer be operated. When the cable 21 is further pulled in this state, the operation target does not move substantially, and the coupling member 3 receives force in a direction of the pulling operation of the cable 21 without rotation. As a result, as shown in FIG. 8, the shaft part 41 having the shaft members 41a, 41b in the pulling operation direction of the cable 21 deforms so as to narrow the gap of the slit SL between the shaft members 41a, 41b due to force from the coupling member 3. Therefore, the coupling member-side facing surface Fa of the coupling member 3 ends up being inclined with respect to the coupling member-side facing surface Fa in the unloaded state (see FIG. 7).

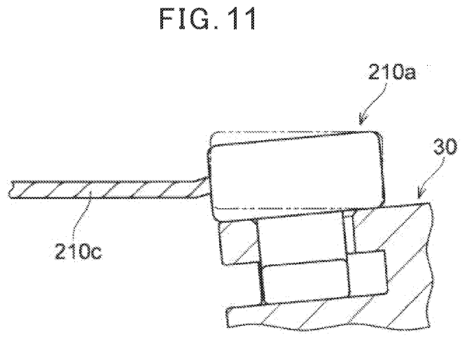

Here, as shown in the Reference example of FIG. 11, in a case of a cable end 210a having no configuration of the present invention and the coupling member 30, when the coupling member 30 is inclined, a part of the cable end 210a facing the coupling member 30 receives force from the coupling member and becomes inclined. When the cable end 210a is inclined with tension being applied to the cable body 210c, bending deformation occurs in the cable body 210c in the vicinity of a connection place between the cable body 210c and the cable end 210a, as shown in FIG. 11. If such bending deformation of the cable body 210c occurs repeatedly each time the cable 210 is operated, the cable body 210c can be fatigue-broken.

In the present embodiment, the coupling member-side facing surface Fa and the cable end-side facing surface Fb are configured not to interfere with each other when the coupling member 3 is inclined with respect to the reference plane. Here, the expression “interfere” between the coupling member-side facing surface Fa and the cable end-side facing surface Fb means that the coupling member-side facing surface Fa interferes with the cable end-side facing surface Fb (presses the cable end-side facing surface Fb) so that the posture of the cable end 21a is changed to cause bending deformation of the cable body 21c in the vicinity of a connection place between the cable body 21c and the cable end 21a when the coupling member 3 is inclined to change its posture. More specifically, the cable end-side facing surface Fb is configured not to be positioned on a moving trajectory of the coupling member-side facing surface Fa when the coupling member 3 receives force from the cable 21 and the coupling member-side facing surface Fa is inclined from the reference plane so that the connection member side facing surface Fa and the cable end-side facing surface Fb are configured not to interfere with each other.

In the present embodiment, as shown in FIGS. 7 to 9, the cable end-side facing surface Fb has inclined surfaces Fb11, Fb21 inclined in the same direction as a direction in which the coupling member 3 is inclined. Angles of the inclined surfaces Fb11, Fb21 with respect to the reference plane (coupling member-side facing surface Fa in the unloaded state) are configured to be equal to or greater than a predetermined inclination angle when the coupling member 3 is inclined from the unloaded state to the predetermined loaded state. As a result, the coupling member-side facing surface Fa and the cable end-side facing surface Fb are configured not to interfere with each other. The inclined surfaces Fb11, Fb21 are inclined so that the separation distance from the base 4 (bottom plate 4a) increases as the inclined surfaces Fb11, Fb21 get farther away from the cable body 21c side. Moreover, the inclined surfaces Fb11, Fb21 are provided on a side farther away from the cable main body 21c, of the cable end-side facing surface Fb. In the cable end-side facing surface Fb, flat surfaces Fb12, Fb22 extending parallel to the coupling member-side facing surface Fa in the unloaded state are provided on a closer side to the cable 21. The flat surfaces Fb12, Fb22 abut on the coupling member-side facing surface Fa (e.g., the upper surface US of the coupling member 3) to allow for the coupling member 3 to support the cable end 21a.

Angles of the inclined surfaces Fb11, Fb21 with respect to the reference plane (coupling member-side facing surface Fa in the unloaded state) may be appropriately set according to a possible inclination angle of the coupling member 3 and are not limited. In the present embodiment, the angles of the inclined surfaces Fb11, Fb21 with respect to the reference plane (coupling member-side facing surface Fa in the unloaded state) correspond to angles of the inclined surfaces Fb11, Fb21 with respect to the flat surfaces Fb12, Fb22. In the present embodiment, although the cable end-side facing surface Fb has inclined surfaces Fb11, Fb21, the inclined surfaces may be provided on the coupling member-side facing surface Fa or may be provided on both the cable end-side facing surface Fb and the coupling member-side facing surface Fa.

As mentioned above, in the present embodiment, the coupling member-side facing surface Fa and the cable end-side facing surface Fb are configured not to interfere with each other when the coupling member 3 is inclined with respect to the reference plane. Therefore, the cable end 21a is suppressed from being inclined along with inclination of the coupling member 3. Accordingly, it is suppressed that the cable body 21c is fatigue-broken due to repeated bending deformation in the vicinity of the cable end 21a. This effect will be described in more detail below.

As shown in FIG. 7, in the unloaded state where no load is applied from the cable 21, the coupling member 3 is not inclined, and the coupling member-side facing surface Fa is in a state substantially parallel to the bottom plate 4a of the base 4. The flat surfaces Fb12, Fb22 of the cable end-side facing surface Fb are likewise supported by the coupling member-side facing surface Fa in a state substantially parallel to the bottom plate 4a of the base 4. The inclined surfaces Fb11, Fb21 of the cable end-side facing surface Fb extend inclining with respect to the coupling member-side facing surface Fa, and are separated from the coupling member-side facing surface Fa in the direction of the axis X.

When the cable 21 is pulled from the unloaded state shown in FIG. 1 where no load is applied from the cable 21, the coupling member 3 rotates around the axis X of the shaft part 41 by the cable 21. When the coupling member 3 rotates to the state shown in FIG. 2, and further the cable 21 is pulled, the shaft part 41 receives force from the coupling member 3 to deform so as to narrow the gap of the slit SL between the shaft members 41a, 41b, as shown in FIG. 8. Therefore, the shaft members 41a, 41b are deflected inwardly in the radial direction of the shaft part 41 so as to incline with respect to the direction of the axis X. As a result, the coupling member 3 that is in contact with the shaft members 41a, 41b at the insertion part 32 is inclined following the deformation inwardly in the radial direction of the shaft part 41. In this way, when the coupling member 3 is inclined and the coupling member-side facing surface Fa is inclined, as shown in FIGS. 8 and 9, a part of the coupling member-side facing surface Fa (a part on the right side of the neck part N, of the coupling member-side facing surface Fa, in FIG. 9) moves from the reference plane in the unloaded state toward the cable end-side facing surface Fb, and another part of the coupling member-side facing surface Fa (a part on the left side of the neck part N, of the coupling member-side facing surface Fa, in FIG. 9) moves from the reference plane in the unloaded state away from the cable end-side facing surface Fb. In the present embodiment, the cable end-side facing surface Fb has inclined surfaces Fb11, Fb21 at a portion facing the coupling member-side facing surface Fa that moves toward the cable end-side facing surface Fb. Further, the cable end-side facing surface Fb is not positioned on the moving trajectory of the coupling member-side facing surface Fa. Therefore, the cable end 21a is suppressed from being pushed by the inclined coupling member 3 and suppressed from being inclined. Accordingly, bending deformation of the cable body 21c connected to the cable end 21a in the vicinity of the cable end 21a is suppressed. Therefore, the cable body 21c is suppressed from being fatigue-broken.

As a modified example of the above-described embodiment, as shown in FIG. 10, the coupling member-side facing surface Fa may have inclined surfaces Fa11 and Fa21. As shown in FIG. 10, the inclined surfaces Fa11 and Fa21 are inclined in a direction opposite to a direction in which the coupling member 3 is inclined. Specifically, the inclined surfaces Fa11 and Fa21 of the coupling member-side facing surface Fa in a portion facing the cable end-side facing surface Fb are inclined so as to approach the bottom plate 4a of the base 4 as the inclined surfaces Fa11 and Fa21 get farther away from the cable main body 21c when the coupling member 3 is in the unloaded state. In the modified example shown in FIG. 10, the cable end-side facing surface Fb has no inclined surface and is configured by a flat surface substantially parallel to the bottom plate 4a of the base 4 in the unloaded state. The cable end-side facing surface Fb can abut on the flat surfaces Fa12 and Fa22 provided on the coupling member-side facing surface Fa in the unloaded state.

Also in this modified example, as shown in FIG. 10, when the coupling member 3 is inclined, the coupling member-side facing surface Fa and the cable end-side facing surface Fb do not interfere with each other, and the cable end 21a is suppressed from being pushed by the inclined coupling member 3 and suppressed from being inclined. Accordingly, bending deformation of the cable body 21c connected to the cable end 21a in the vicinity of the cable end 21a is suppressed, and the cable body 21c is suppressed from being fatigue-broken.

In addition, although not shown, as a further modified example, both the coupling member-side facing surface Fa and the cable end-side facing surface Fb may be provided with inclined surfaces. In this case, for example, the inclined surface provided on the cable end-side facing surface Fb may be inclined so that a distance from the bottom plate 4a increases as the inclined surface get farther away from the cable body 21c, and the inclined surface provided on the coupling member-side facing surface Fa may be inclined so that a distance from the bottom plate 4a decreases as the inclined surface gets farther away from the cable body 21c. Also in this modified example, when the coupling member 3 is inclined, the coupling member-side facing surface Fa and the cable end-side facing surface Fb do not interfere with each other, and the cable end 21a is suppressed from being pushed by the inclined coupling member 3 and suppressed from being inclined. Accordingly, repeated bending deformation of the cable body 21c connected to the cable end 21a in the vicinity of the cable end 21a is suppressed, and the cable body 21c is suppressed from being fatigue-broken.

In the above-described embodiment, only the cable 21 is shown so that the coupling member-side facing surface Fa and the cable end-side facing surface Fb do not interfere with each other, and the cable end 22a of the second cable 22 and the cable end 23a of the third cable 23 are schematically shown. However, the cable end 22a of the second cable 22 and the facing surface of the coupling member 3 facing the cable end 22a, and the cable end 23a of the third cable 23 and the facing surface of the coupling member 3 facing the cable end 23a may have the similar configuration as the coupling member-side facing surface Fa and the cable end-side facing surface Fb mentioned above.

### REFERENCE SIGNS LIST

1 Operating device
21, 210 Cable
21a, 21b, 210a Cable end
21c, 210c Cable body
22 Second cable
22a Cable end (second cable end)
22b Cable end
22c Cable body
23 Third cable
23a Cable end (third cable end)
23b Cable end
23c Cable body
3, 30 Coupling member
3a First part
3b Second part
31 Connecting part
31a Opening
32 Insertion part
33 Second connecting part
33a Cable passage slit
34 Third connecting part
34a Cable passage slit
4 Base
4a Bottom plate
4b, 4c, 4d, 4e Side wall
41 Shaft part
41a, 41b Shaft member
411 Base end part
412 Tip part
Biasing member
B Cable end base end part
BS Bottom surface of coupling member
CL Claw part
Fa Coupling member-side facing surface
Fa1 First coupling member-side facing surface
Fa2 Second coupling member-side facing surface
Fa11, Fa21 Inclined surface
Fa12, Fa22 Flat surface
Fb Cable end-side facing surface
Fb1 First cable end-side facing surface
Fb2 Second cable end-side facing surface
Fb11, Fb21 Inclined surface
Fb12, Fb22 Flat surface
G1, G2, G3 Engagement groove
LS Lateral side of coupling member
N Neck part
OC1, OC2, OC3 Outer casing
SL Slit
T Cable end tip part
US Upper surface of coupling member
X Axis of shaft part

1. An operating device, comprising:
a cable having a cable end;
a coupling member to which the cable end is coupled, the coupling member being activated when the cable is operated; and
a base to which the coupling member is operably provided,
wherein the coupling member comprises a connecting part to which the cable end is connected,
wherein the connecting part has a coupling member-side facing surface facing a part of the cable end when the cable end is connected to the connecting part,
wherein the coupling member-side facing surface of the coupling member is provided to the base so as to be inclined at a predetermined inclination angle with respect to a reference plane when the coupling member is in a predetermined loaded state where a predetermined load or more is applied from the cable, and the reference plane is a position of the coupling member-side facing surface in an unloaded state where no load is applied from the cable,
wherein the cable end has a cable end-side facing surface facing the coupling member-side facing surface, and
wherein the coupling member-side facing surface and the cable end-side facing surface are configured not to interfere with each other when the coupling member is inclined with respect to the reference plane.

2. The operating device of claim 1,
wherein the cable end-side facing surface has an inclined surface inclined in the same direction as a direction in which the coupling member is inclined, and
wherein an angle of the inclined surface with respect to the reference plane is equal to or greater than the predetermined inclination angle when the coupling member is inclined from the unloaded state to the predetermined loaded state.

3. The operating device of claim 2,
wherein the base comprises a shaft part serving as a rotation axis of the coupling member,
wherein the shaft part comprises a plurality of shaft members separated from each other by a slit extending along a direction of an axis of the shaft part, and
wherein, in the predetermined loaded state, the shaft member receives force from the coupling member so that a tip part is deflected inwardly in a radial direction of the shaft part with respect to a base end part of the shaft member, thereby inclining the coupling member mounted to the shaft part.

4. The operating device of claim 3, further comprising:
a second cable and a third cable, both of which are operated via the coupling member when the coupling member is operated by the cable,
wherein, in the coupling member, a second cable end of the second cable is mounted to an opposite side to the cable end of the cable across the shaft part, and
wherein, in the coupling member, a third cable end of the third cable is mounted at a same position as a position of the cable end of the cable in a rotation direction of the coupling member, and the cable end of the cable and the third cable end of the third cable are provided so as to be aligned in the direction of the axis of the shaft part.

5. The operating device of claim 1,
wherein the base comprises a shaft part serving as a rotation axis of the coupling member,
wherein the shaft part comprises a plurality of shaft members separated from each other by a slit extending along a direction of an axis of the shaft part, and
wherein, in the predetermined loaded state, the shaft member receives force from the coupling member so that a tip part is deflected inwardly in a radial direction of the shaft part with respect to a base end part of the shaft member, thereby inclining the coupling member mounted to the shaft part.
